(19) United States
(12) Patent Application Publication
(10) Pub. No.: US 2026/0196830 A1
(43) Pub. Date: Jul. 9, 2026

(54) GRID FORMING CONTROL OF GRID CONNECTED POWER CONVERTER

(71) Applicant: VESTAS WIND SYSTEMS A/S, Aarhus N (DK)

(72) Inventors: Gert Karmisholt ANDERSEN, Hovedgård (DK); Hong GONG, Aalborg Øst (DK)

(21) Appl. No.: 19/131,688

(22) PCT Filed: Dec. 27, 2023
(86) PCT No.: PCT/DK2023/050334

§ 371 Date: May 21, 2025

(30) Foreign Application Priority Data
Dec. 30, 2022 (DK) PA202270655

(51) Int. Cl. H02J 3/001; H02J 3/0014; H02J 3/02; H02J 3/11; H02J 3/1885; H02J 101/28; H02J 103/35

(52) U.S. Cl. CPC H02J 3/00125; H02J 3/00142; H02J 3/02; H02J 3/11; H02J 3/1885; H02J 2101/28; H02J 2103/35

(57) ABSTRACT

A method for controlling a grid connected power converter configured to supply power to a grid from a power source, the method comprising: determining a grid voltage reference (Pref_VMP) for controlling the power converter; controlling a first power component being supplied to the grid by the power converter by controlling the power converter (202) using a first grid forming controller configured to control the output voltage towards the grid voltage reference (Pref_VMP), the first grid forming controller operating according to a first grid forming algorithm being configured to output a first voltage component for supplying the first power component to the grid; controlling a second power or voltage component being supplied to the grid by the power converter by controlling the power converter using a second grid forming controller, operating in parallel to the first grid forming controller, the second grid forming controller operating according to a second grid forming algorithm being configured to output a second voltage component for supplying the second power or voltage component to the grid; combining the second output voltage component of the second grid forming algorithm with the first output voltage component of the first grid forming algorithm; and operating the power converter according to the combined output voltage from the first grid forming controller and the second grid forming controller.

### FIELD OF THE INVENTION

The invention relates to control of grid connected power converters, and particular control of power peaks in response to transient grid events.

### BACKGROUND OF THE INVENTION

In order to allow a higher penetration of renewable energy sources, such as wind turbines, in the electrical grid it has been proposed requirements to equip the power converters of such energy sources with grid-forming properties similar to conventional synchronous generators. These requirements can be addressed, for example, by configuring the renewable power generating units as virtual synchronous machines, VSM.

When, e.g., a wind turbine is configured to be operated as a VSM or according to other grid forming control schemes, grid disturbances, such as phase jumps, may lead to high peaks in the generator power and/or generator torque, and thereby undesired transient mechanical loads.

Accordingly, it is a problem that wind turbines and other rotating power sources configured operating according to a grid forming control scheme may experience high mechanical loads in response to grid disturbances.

### SUMMARY OF THE INVENTION

It is an object of the invention to improve control of grid connected power converters, such as power converters of wind turbines, being configured to be controlled according to a grid forming control scheme in order to alleviate problems with transient mechanical loads.

According to a first aspect of the invention it is provided a method for controlling a grid connected power converter configured to supply power to a grid from a power source. The method comprising:
determining a grid voltage reference for controlling the power converter;
controlling a first power component being supplied to the grid by the power converter by controlling the power converter using a first grid forming controller configured to control the output voltage towards the grid voltage reference, the first grid forming controller operating according to a first grid forming algorithm being configured to output a first voltage component for supplying the first power component to the grid;
controlling a second power or voltage component being supplied to the grid by the power converter by controlling the power converter using a second grid forming controller, operating in parallel to the first grid forming controller, the second grid forming controller operating according to a second grid forming algorithm being configured to output a second voltage component for supplying the second power or voltage component to the grid;
combining the second output voltage component of the second grid forming algorithm with the first output voltage component of the first grid forming algorithm; and
operating the power converter according to the combined output voltage from the first grid forming controller and the second grid forming controller.

As was mentioned, requirements to equip power source power converters, such as wind turbine power converters, with grid-forming properties that exhibit similarities to the behavior of conventional synchronous generators may be desired or even required. This may be accomplished by operating the power converter according to a grid forming control scheme using a grid forming controller.

In the grid forming control scheme, the power converter is controlled to produce an output voltage according to a grid voltage reference, where the grid voltage reference may be a reference provided, e.g., by an electrical grid operator, or an operator of, e.g. a wind farm, and where a plurality of power sources may be connected to the electrical grid for providing power. The grid voltage reference may comprise a voltage amplitude and frequency to be maintained by the particular wind turbine generator or other type of power source. The voltage reference may also be determined according to other criteria. This may be the case, for example, if the power source is be configured to set up, e.g., a local electrical grid, i.e. operate in an island mode, where the voltage amplitude may be adapted according to the particular need for power of the connected consumers. Hence, in grid forming control, a power source such as a wind turbine generator may create a power grid by powering otherwise depowered power lines.

The grid forming control is hence different from a more conventional grid following control, where, instead, grid-following converters synchronize to the currently prevailing grid voltage amplitude and frequency, where the power converter adjusts the output voltage to track an external voltage reference, which is given by the currently prevailing voltage on the electrical grid.

In a steady state mode, the power balance in a grid following control is essentially such that the torque and speed of the electrical generator are constant, and hence the power output by the electrical generator. The power converter may comprise a machine side converter and a line side converter, where a DC link voltage of a DC link interconnecting the machine side converter and the line side converter is also constant, while the voltage output by the line side converter is variable so that the current being injected into the grid is adapted in amplitude to correspond to the prevailing power that is delivered by the electrical generator.

In case a fault or an unexpected event occurs in the electrical grid, the line side controller, when operating according to grid following control, in principle, will continuously adjust the voltage to the currently prevailing voltage on the grid, hence also in situations when the grid voltage deviates from the voltage the grid is intended to maintain. The grid following power converter hence does not support the rigidity of the grid in situations of this kind, but simply follows voltage changes as they occur, and continue to provide the power generated by the electrical generator to the grid at the voltage amplitude and angle that the grid currently is operating at by adjusting the injected current in accordance therewith so that the injected power remains essentially the same.

The machine side converter of such a power converter, and thereby also the electrical generator, are hence substantially unaffected when abnormal grid events occur when operating in the grid following mode, since the produced power is continuously delivered to the DC link and onwards towards the grid irrespective of the prevailing grid voltage. The electrical generator, and other drive train components, can therefore be seen as being decoupled from the grid in terms of changes occurring on the grid, and therefore these components are also not subjected to potentially harmful voltage or torque transients because of changes in the grid voltage, since the power provided by the electrical generator can be continued to be provided to the grid at the same power level. The apparent drawback of such control is the lack of support for system stability, which will have a higher and higher impact the larger the number of power sources that are connected to the grid in this manner.

Stability problems may, as was mentioned, be alleviated by the power source, instead, being controlled according to a grid forming control where the power converter instead is configured to act as a grid stabilizer. The power converter is then configured to control the output voltage towards a voltage reference and maintain this voltage reference, irrespective of the actually prevailing grid voltage in order to support the maintaining of the intended voltage.

This improves the stability of the grid, but as a result grid events, in particular transient changes, may impose harmful torque transients on mechanical components, such as wind turbine generator components. If something then happens in the grid, there will be an immediate current response that follows automatically when continuing to control the output of the power converter towards the voltage reference. This will have the result that the current being injected into the grid, instead, will be a direct result of the voltage control of the power converter.

As a result, when the grid is subjected to transients, the current to be injected into the grid may also exhibit transients, and this will also affect the control of a DC link voltage of the power converter when transients in DC link current occurs. In general the machine side controller controls the DC link voltage, and in order to maintain the DC link voltage at a DC link voltage reference, the request for power from the electrical generator undergoes corresponding transient changes to compensate for changes in the DC link, with the result that the transients may transplant to the machine side converter and thereby also to the electrical generator and other drive train components providing power to the machine side converter. For example, the aerodynamical rotor, as well as the electrical generator and the gearbox interconnecting the rotor and the electrical generator of a wind turbine generator will be directly affected by such torque changes, and components of this kind do not react well to harmful torque spikes which May cause excessive wear. Also, components of the power converter may break if subjected to, e.g., excessive current spikes.

Furthermore, there oftentimes exist various power components that are desired to control in order to control operation of the system. For example, there may be various damping powers that are applied to dampen harmful oscillations and which need to be injected into the grid. Such power components may be difficult to control using regular grid forming control.

According to the invention, it is provided a control method that provides the desired grid forming control, while simultaneously alleviating mechanical components as well as converter components from excessive wear caused by transient events occurring on the grid, and which method also provides a means for controlling various other parameters such as damping powers.

According to the first aspect of the invention, a voltage reference for controlling the power converter is determined, where this may be carried out as described above with regard to grid forming control, and hence be a voltage that the power converter is to control the output voltage towards also when a voltage changing grid event occurs.

Furthermore, a first power component being supplied to the grid is controlled by controlling the power converter using a first grid forming controller configured to control the output voltage towards the grid voltage reference, where the first grid forming controller operate according to a first grid forming algorithm that is configured to output a first voltage component for supplying the first power component to the grid. Hence, the general control of the power converter is a grid forming control to provide a grid stabilising control as this is oftentimes desired.

Use of this grid forming control alone, however, would, as discussed, provide the general disadvantages of grid forming control, where normally a transient change in the power supplied to the grid will be reflected in the power reference for the power control of the electrical generator, with possible harmful transients in mechanical components arising as a result in the sudden change in requested power.

According to the invention, such transients can be at least mitigated, or partly or fully eliminated by imposing a further control mechanism for controlling power converter. In particular, in addition to controlling the power controller according to a first grid forming controller, the power converter is also controlled according to a second grid forming controller, operating in parallel to the first grid forming controller, where the second grid forming controller operate according to a second grid forming algorithm that is configured to output a second voltage component for supplying a second power or voltage component to the grid. The second output voltage component is combined with the first output voltage component of the first grid forming algorithm; and the power converter is operated according to the combined output voltage from the first grid forming controller and the second grid forming controller. The second grid forming algorithm may be the same algorithm as is utilized in the first grid forming controller, however with the difference that it is being differently parametrized. According to embodiments of the invention, each grid forming controller is configured to output a voltage component having a frequency and a phase angle.

The use of two (or more, as the case may be) parallel grid forming converters that are controlled to output different voltage components allow that, e.g. high-frequency, or low-frequency, voltage components may be supplied to the grid utilizing the one or more parallel grid forming converters while the first grid forming control may be configured to handle the majority of the voltage component of the power reference, and thereby the majority of the power being injected into the grid. In this way, the impact of, e.g., high-frequency transients on mechanical components can be reduced by returning power to the grid utilizing one or more parallel grid forming converters to thereby relieve mechanical components from stress. The one or more additional grid forming controllers may be designed to provide a faster control than the main first grid forming controller, and thereby also be more suitable to carry out control of, e.g., transient events and also other parameters that there exist a desired to control. The impact of each grid forming controller on the combined output voltage may be controlled by means of a weight factor, the weight factor limiting the amount of power to be injected into the grid by the particular grid forming controller, where hence the grid forming controllers may be provided with different weight factors.

According to embodiments of the invention, a bandwidth of a frequency band of the second output voltage component is different from a bandwidth of a frequency band of the first output voltage component. Hence the grid forming controllers may be used to control voltage components of different frequencies to account for, e.g., voltage control and/or damping power control that require other frequencies to be controlled in order to provide for a desired operation of the power source installation, such as wind turbine generator, that the power converter is configured to control. The frequency band or bands being controlled by the second and/or the at least one additional grid forming controller may comprise higher or lower frequency components than the frequency band being controlled by the first grid forming controller.

According to embodiments of the invention, at least one additional voltage or power component being supplied to the grid by the power converter is controlled by controlling the line side converter using at least one additional, i.e. third, grid forming controller, operating in parallel with the first and second grid forming converter, each of the at least one additional grid forming converters operating according to a grid forming algorithm, respectively, for supplying a power or voltage component to the grid;
the output voltage component(s) of the at least one additional grid forming controller being combined with the output voltage components of the first and second grid forming controllers; and
operating the power converter according to the combined output voltage from the first, second and the at least one additional grid forming controller.

Hence, a plurality of grid forming controllers, each having a grid forming algorithm, may be utilized to operate in parallel, to thereby control various powers and/or voltages, where each grid forming controller may be designed specifically for the parameter it is designed to control.

According to embodiments of the invention, at least one, or each, of the at least one additional grid forming controllers is configured to output a voltage component with a frequency band being at least partly non-overlapping with a frequency band of the first output voltage component, and/or wherein each grid forming controller is configured to output a voltage component with a frequency band being different from the frequency band of the first output voltage component and/or being different from any output voltage component of any other grid forming controller. In this way, various different frequency components may be configured to be controlled, where each grid forming controller may be designed, e.g., by suitable parametrization of the grid forming algorithms, to control, e.g. voltage or power components being comprised by a particular frequency band.

According to embodiments of the invention, the frequency range of the output voltage component being output by the second and/or at least one additional grid forming controller may be controlled utilizing a band-pass filter, a low-pass filter, and/or other type of filter so as to further separate components being controlled by one grid forming converter from components being controlled by other grid forming converters.

According to embodiments of the invention, each grid forming controller comprises an algorithm, such as a swing equation, each algorithm having a parametrization being different from the parametrization of the one or more other algorithms. Hence similar algorithms may be used, albeit with different parametrization being adapted for the particular control of the grid forming controller, respectively. Furthermore, the algorithms may comprise a swing equation, which is common method of grid forming control.

When the algorithms comprise swing equations, each swing equation may be configured to control a power component, respectively, through output of a voltage component utilizing one or more from an integrator, an inertia time constant and a damping of frequency deviation, parameters of the integrator, inertia time constant and damping of frequency deviation being different for the different swing equations. In this way, the grid forming controllers may be adapted in a straightforward manner to the particular control that is to be carried out.

According to embodiments of the invention, each grid forming control controller is configured to control a voltage or power component in dependence of a power or voltage refence, the grid forming algorithm of the grid forming controller being configured to output an output voltage component in response to the difference to be combined with output voltage component of the at least one other grid forming controller. This allows that differences in relation to a reference value is compensated for in order to control the voltage or power component towards the reference value.

According to embodiments of the invention, power output by an electric generator forming the power source by a drive train damping power is compensated in order to dampen drive train fundamental frequency oscillations, wherein the drive train damping power is compensated by supplying the drive train damping power to the grid, the drive train damping power being supplied to the grid utilizing the second or one of the at least one additional grid forming controllers. In this way, the drive train damping power may be compensated for in an efficient manner, since a grid forming controller can be designed to specifically control, e.g., only this, power, and thereby also in a way that allows a considerably faster adaption to changes in the requirements for compensation than would be the case if the drive train damping power had to be controlled by the main grid forming controller.

According to embodiments of the invention, a DC link electrically connects an output of a machine side converter to an input of a line side converter, where the DC link voltage of the DC link is controlled towards a DC link voltage reference utilizing the second or one of the at least one additional grid forming controllers, wherein the grid forming controller outputs an output voltage component controlling the DC link voltage towards the DC link voltage reference. In this way a control of the DC link voltage is carried out in parallel to the general grid forming control of the power being injected into the grid, where the output voltage of the grid forming control is subjected to an addition, i.e. correction, by the voltage output from the grid forming controller carrying out the DC link control. This will at least in part compensate for transient events, so that a power source do not solely need to account for such transient changes.

According to embodiments of the invention the first grid forming controller is configured to control the majority of the power being injected into the grid by the power converter. Hence, a main grid forming controller may be configured to control most of the power, while the other one or more grid forming controllers may be configured to control smaller power components that improves the overall operation of the system.

According to embodiments of the invention, SSTD (side-side-tower-damping) and/or POD (power oscillation damping) and/or other kinds of mechanical damping can be compensated, e.g. in a manner similar to the compensation of drive train damping, where the SSTD and/or POD and/or the other mechanical damping is compensated by supplying the SSTD and/or POD and/or other mechanical damping compensating power to the grid, utilizing the second and/or one or more of the at least one additional grid forming controllers.

### BRIEF DESCRIPTION OF THE DRAWINGS

Embodiments of the invention will be described, by way of example only, with reference to the drawings, in which:

FIG. 1 illustrates a wind turbine;

FIG. 2A illustrates an example of a power system of a wind turbine or a power generating unit;

FIG. 2B illustrates control components arranged for controlling the generation of active power and reactive power supplied to the grid at the power output of the wind turbine or power generating unit;

FIG. 3 illustrates an example of combined grid forming controllers according to the invention;

FIG. 4 illustrates a further example of combined grid forming controllers according to the invention;

FIG. 5 illustrates another example of combined grid forming controllers according to the invention;

### DETAILED DESCRIPTION

The invention will be exemplified for a wind turbine in the following, but the invention is not limited to wind turbines as power sources for the power to be injected into a grid by a power converter.

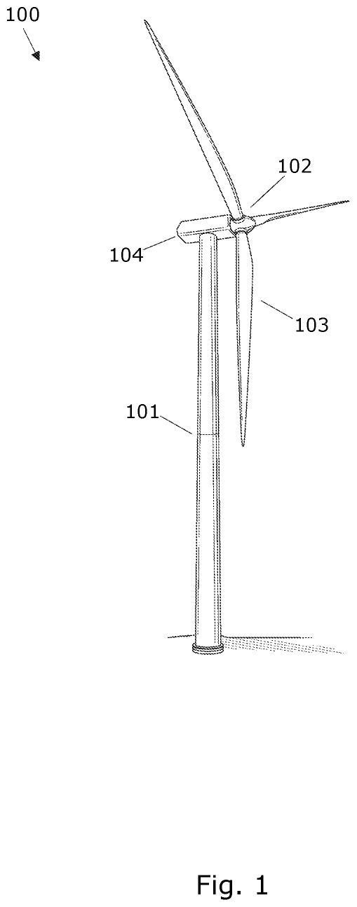

FIG. 1 shows a wind turbine 100 (WTG) comprising a tower 101 and a rotor 102 with at least one rotor blade 103, such as three blades. The rotor is connected to a nacelle 104 which is mounted on top of the tower 101 and being adapted to drive an electrical generator situated inside the nacelle via a drive train. The rotor 102 is rotatable by action of the wind. The wind induced rotational energy of the rotor blades 103 is transferred via a shaft, and oftentimes, as in the present case, a gearbox, to an electrical generator. The wind turbine 100 is hence capable of converting kinetic energy of the wind into mechanical energy by means of the rotor blades and, subsequently, into electric power by means of the electrical generator. The electrical generator is connected to a power converter which comprises a generator, or machine, side converter and a line side converter. The machine side converter converts the generator AC power into DC power and the line side converter converts the DC power into an AC power for injection into the grid.

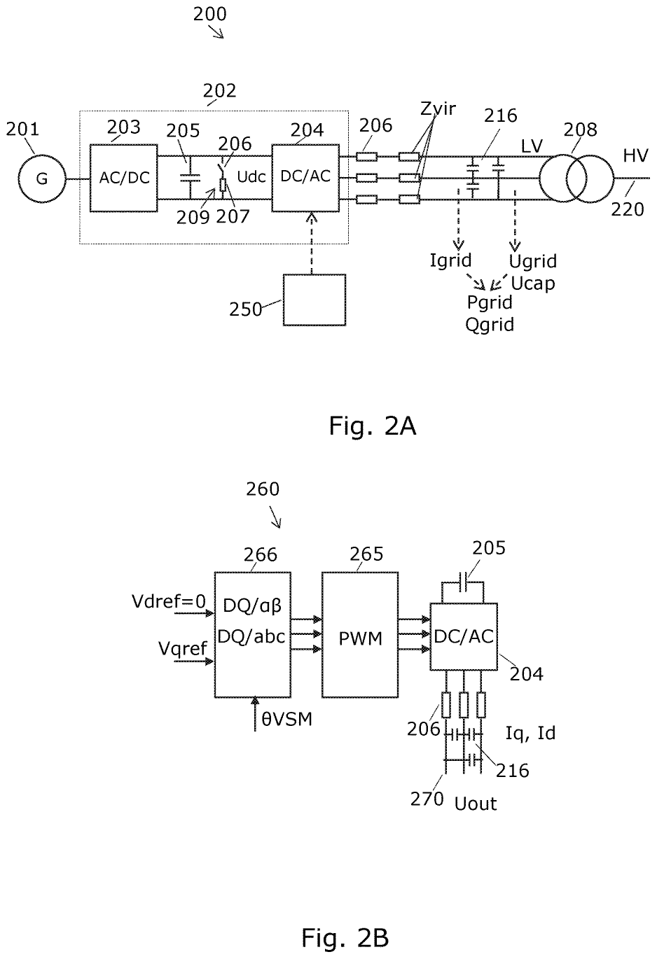

FIG. 2A shows an example of a power system 200 of a wind turbine such as the wind turbine 100 of FIG. 1 more in detail. The power system 200 comprises an electrical generator, or power source, 201, which according to the above is connected to the rotor 102 of the wind turbine 100, where oftentimes the drive train comprises a gearbox (not shown) connecting the rotor to the electrical generator. The power system 200 further comprises a power converter 202. The power converter 202 comprises, according to the present example, a machine side converter 203, a line side converter 204 and a DC-link 205 therebetween, where in use a DC link voltage Udc is present. The power converter 202 may further comprise a resistor 207 connected with a controllable switch 206. The resistor and switch form a power dissipation device, also known as a chopper 209, for dissipating active power if the need for this arises which may be the case, e.g., if the wind turbine operates in island mode.

The DC-link 205 comprises one or more DC-link capacitors which are charged by the DC output current from the machine side converter 203 and which supplies DC power to the line side converter 204. The output AC current from the line side converter 204 may be supplied via output inductors 206 and possibly via a wind turbine transformer 208 to the grid or power line 220. In this example, the output AC current is a 3-phase current output. Furthermore, harmonic filter capacitors 216 may be arranged between the conductors of the output, which together with the inductors 206, forms a harmonic filter which converts the square wave voltage signals from the line side converter 204 to voltage sinusoidal signals.

The power line 220 may be a medium voltage power bus which receives power from other wind turbines 100. The power line 220 may be connected to a high voltage network, e.g. via further transformers. Thus, the power line 220 and one or more power systems 200 of corresponding wind turbines constitutes a wind power plant or park arranged to supply power to a utility grid for distribution of electrical power. The power line 220 and the high voltage network is commonly referred to as a power grid, or grid, herein.

The power converter 202 may be full-scale converter configured according to different principles including forced-commutated and line-commutated converters.

The power system 200 is only schematically illustrated and the system may be a three-phase system. However, principles of the described embodiments apply both to single and multi-phase systems.

The line side converter 204 utilizes pulse width modulation (PWM) for converting the DC power into AC power. The control system 250 is used for controlling the modulation of the line side converter 204 and for controlling the active power P and the reactive power Q generated by the line side converter 204.

FIG. 2A shows that the grid voltage Ugrid, here the voltage at the low voltage LV side of the transformer 208, can be measured. The grid voltage Ugrid can be used for controlling the power output of the converter, based on determining the active power Pgrid from grid voltage Ugrid and grid current Igrid. The reactive power Qgrid may similarly be determined from Ugrid and Igrid. Alternatively, the grid voltage Ugrid may be measured on the high voltage HV side of the transformer and corrected based on the turns ratio of the transformer, or the internal voltage magnitude reference Vqref is used instead of the measured voltage Ugrid. In an alternative, an internal voltage magnitude reference such as Vqref, Vdqref or Vαβref may be used for determining Pgrid. The grid current Igrid supplied to the grid can also be measured.

FIG. 2B shows an example of control components 260 arranged for controlling the generation of active power Pgrid and reactive power Qgrid supplied to the grid at the power output 270 of the wind turbine 100. That is, the control components 260 may be arranged for controlling the output active power Pgrid and the output voltage magnitude at the low voltage side LV, alternatively for controlling the output active power Pgrid and the output reactive power Qgrid at the low voltage side LV. The control components 260 such as the frame conversion unit 266 and the pulse width modulator 265 may form part of the control system 250 or receive control signals from the control system 250.

References for the active and reactive power may be received from a power plant controller, PPC, or a grid operator, or be determined from active and reactive power references, e.g. from the grid operator. The illustrated system may be utilized in grid forming control, e.g. based on a virtual synchronous machine angle θVSM as illustrated in the figure.

As was discussed above, the power converter may be controlled according to different control strategies, where historically a grid following methodology has been utilized. As was also mentioned, an advantage of the grid following control scheme is that since the line side controller controls the voltage in accordance with the prevailing voltage on the grid, the line side converter will immediately react to changes that occur on the grid and adjust, e.g., the current so that still the amount of power being injected into the grid corresponds to the amount of power being provided to the DC link by the machine side controller.

However, as was also discussed, there may exist a requirement from, e.g., a grid operator that the wind turbine generator take part in the forming of the grid and assists in the maintaining of the stability of the grid when stability affecting grid events occur. When the wind turbine generator operates according to a grid forming control scheme instead of a great following control speed the line side converter is operated to output a fixed voltage irrespective of any stability influencing negative events occurring on the grid.

This may be accomplished through the use of a grid forming algorithm, where such grid forming algorithms may be of different kinds. For example, the active power, Pgrid, may be controlled using a virtual synchronous machine angle, θVSM as is schematically indicated in FIG. 2B. In short, the synchronous machine angle acceleration (the double-time derivative of θVSM) corresponds to the difference between a power reference Pref for a desired power output of the wind turbine and a grid power Pgrid that is actually supplied by the wind turbine to a power grid.

The synchronous machine angle θVSM may be determined according to a grid forming converter scheme such as, but not limited to, a virtual synchronous machine control scheme. A grid forming converter scheme models the inherent rotating mass inertia of conventional synchronous generators. By modelling the inertia, the converter may provide improved grid stability by the grid forming converter model opposing changes in grid frequency. That is, an increase in the grid frequency causes an increase of the kinetic energy and rotation frequency of the inertia but with a response time determined by the inertia. Oppositely, a decrease in the grid frequency causes a decrease of the kinetic energy and frequency of the inertia but with a response time determined by the inertia. In a wind turbine, the increase or decrease of the kinetic energy of the modelled synchronous generator causes an increase or decrease of the kinetic energy of the rotor 102.

The synchronous machine angle θVSM may be used to transform the signals from a rotating DQ frame into a non-rotating frame such as the αβ or abc frame, or vice-versa. Based on the synchronous machine angle θVSM and voltage magnitude reference Vqref, control signals for the desired active power and reactive power are determined.

The synchronous machine angle θVSM may be defined in a rotating DQ frame defined by the angular position θVSM and rotating with the frequency ωVSM. Based on the synchronous machine angle θVSM, control signals, i.e. the angle of the modulation voltage signals for the pulse-width-modulator PWM, 265 are determined and transformed into a non-rotating frame such as the αβ or abc frame. The modulation voltage reference signal controls the active and reactive power Pgrid and Qgrid.

The frame conversion unit 266 transforms the control signal from the DQ frame into the αβ or abc frame and determines the sinusoidal voltage references for the PWM 265. The frame converted output signals from the frame conversion unit 266 are converted by the pulse-width-modulator PWM, 265 into a modulation signal for the grid side converter 204 in order to generate the desired active power and reactive power and/or voltage magnitude.

The voltage magnitude reference Vqref is provided as a reference for a desired grid voltage or a desired reactive power Qgrid to be generated by the converter 204. The voltage magnitude reference Vqref may be determined based on a difference between a reactive power reference Qref and an actual reactive power Qgrid delivered to the grid. Thus, the reactive power Qgrid to be generated by the line side converter 204 can be controlled based on a voltage magnitude reference Vqref.

The voltage magnitude reference Vqref may be defined in the DQ frame which rotates with the rotational speed ωVSM of the virtual synchronous machine, which in a steady state condition may equal the fundamental frequency such as 50 Hz of the AC grid voltage. The voltage magnitude reference Vqref, or a modification thereof as described in the following, may be converted from the DQ frame to the αβ or abc frame and outputted from the frame conversion unit 266 as a control signal to the pulse-width-modulator PWM, 265 which determines the modulation signal for the grid side converter 204. With regard to the DQ frame, it is to be noted that in the present description a generator notation of, e.g., Id, Iq, Ud, Uq, etc. is utilized, which differs from the general motor notation of, active and reactive currents and voltages.

As was mentioned, in a conventional synchronous machine the inherent inertia may be utilized for purposes of stabilizing the grid. In a wind turbine, the increase or decrease of the kinetic energy of the modelled synchronous generator causes an increase or decrease of the kinetic energy of the rotor 102. If these changes are transient, there will be a corresponding transient change in requirement for kinetic energy of the rotor 102, and thereby also other mechanical components.

Depending on the governing grid codes for a wind turbine power plant, the power converters of wind turbines may be required to be operated as virtual synchronous machines, at least for grid currents Igrid below a given overcurrent threshold. If the overcurrent threshold is high, grid disturbances like phase jumps may lead to a high power peak or torque peak in the generator side and drive train and consequently cause an undesired increase in the mechanical load.

For example, as was stated, the rotor carrying the wings, the electrical generator as well as the gearbox interconnecting these components may be sensitive to torque spikes to high degree. It is therefore highly undesirable to have high torque spikes occurring in the drivetrain since this may provide excessive wear and reduce lifetime expectancy of the components therein. This may therefore provide a challenge when it comes to controlling a wind turbine generator according to a grid forming control scheme.

According to the invention, it is provided a method of mitigating problems of this kind, where the grid forming control scheme is still utilized, but where an additional grid forming control scheme is used in parallel to mitigate, e.g., the impact of possible transients. According to embodiments of the invention it is instead, or in addition, provided for control of one or more power components, such as drive train damping etc. as is further explained below.

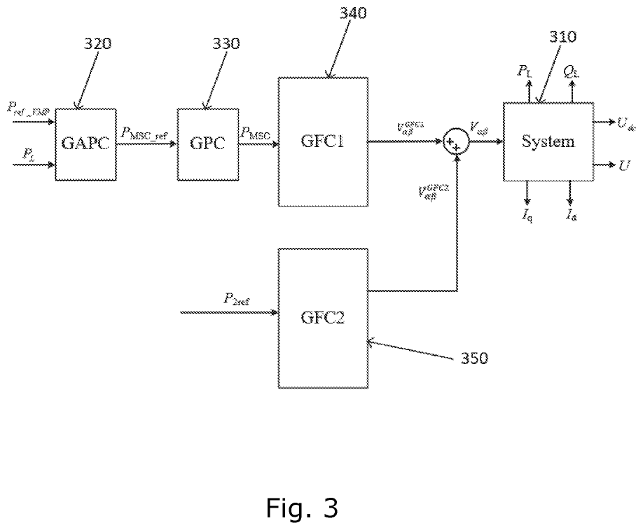

FIG. 3 illustrates a general principle according to the invention. In the figure, the line side converter and the associated control of the line side converter is schematically illustrated by the box 310, also denoted “system”. The system box 310 is furthermore responsible for determining measures of the active power PL that goes into the grid as well as the reactive power QL being injected into the grid. These measures may, for example, be determined from the grid voltage Ugrid and the grid current Igrid, which, as may be measured according to the above or according to alternative voltages measurements as was also stated. The active and reactive currents may also be established from these measures.

Measurements of the DC link voltage Udc, which, e.g., may be measured on the input side of the line side converter may also be represented by this box, where the DC link voltage Udc may be utilized according to embodiments of the invention for control of the DC link voltage.

During constant operating conditions, the power PL being injected into the grid by the line side converter will be essentially the same as the power PMSC being provided by the machine side converter. However, the power being injected into the grid PL may need to be compensated for, e.g., power being drawn by auxiliary devices of the wind power converter and/or losses and/or other powers. According to the present example, there is therefore a generator active power controller GAPC 320 that takes as input the power reference Pref_VMP, which represents the desired power output of the wind turbine, and the power PL being injected into the grid and outputs a machine side active power reference PMSC_ref. Hence the actual power to be produced by the electrical generator may be set to the desired power output compensated for losses etc. so that the actually injected power PL corresponds to the power reference Pref_VMP. The machine side active power reference PMSC_ref is hence used to control the electrical generator, using the generator power control GPC 330 and the machine side converter to obtain the desired power on the DC link.

As was stated, references for the active Pref_VMP as well as for the reactive power may be received from a power plant controller, PPC, or a grid operator, or be determined from active and reactive power references, e.g. from the grid operator. The power reference may reflect the power that is extracted from the wind, and hence may change e.g. in accordance with what the wind turbine generator is currently producing. Thus, the power reference Pref_VMP may reflect e.g. power changes caused by changes in the wind. In this way a power balance on the drivetrain is also obtained.

As was stated, the line side converter controls the output voltage based on a voltage input, such as a voltage Vαβ. This voltage input Vαβ consists, according to the present example, of two voltage components which will be explained in the following.

The power PMSC provided to the DC link by the machine side converter is utilized by a first grid forming controller GFC1 340 to determine an output voltage VGFC1, αβ to be output by the line side converter to obtain the desired power output, where, e.g. a grid forming control utilizing a virtual synchronous machine angle may control the active power being injected into the grid. It is to be noted that the output voltage component VGFC1, αβ may be generated according to any suitable grid forming control algorithm, and is hence not limited to controlling the line side converter according to a virtual synchronous machine. For example, virtual oscillator grid forming, and/or moving average filtering grid forming may be utilized as alternatives to controlling the line side converter as a virtual synchronous machine. The grid forming control GFC1 340 carries out the required calculations based on a the power being output by the machine side converter.

The control according to GFC1 340 in FIG. 3 is hence set out to control the line side converter according to a voltage reference. Use of this control alone, however, as is in general the case, exhibit drawbacks as explained above, since the electrical generator is no longer decoupled from the grid from a transient point of view in the same manner as when being controlled according to grid following control scheme because the rest of the system has to adapt to the control of the line side converter. The generator power control GPC will adapt to the power PL currently being input into the grid by the line side controller.

During normal operation there will be a balance between the power being output by the line side converter and the power being produced by the electrical machine. The power reference from the turbine Pref_VMP is respected since this reference provides information regarding the amount of power that can be injected into the grid according to the current power being extracted by the wind. However, if transients arise in the grid, the grid forming control GFC1 calls for the grid voltage to be maintained, and this will cause transients in the current that will be injected into the grid as a result of the maintaining of the voltage reference. Thereby, there will also be a transient change in the power PL being injected into the grid by the line side converter, and as a consequence there will be a transient change in torque request from the electrical generator since a change in current output by the line side converter will be directly reflected by a change in the request for torque by the electrical generator. The DC link is in general very limited in terms of energy storage, and hence cannot account for sudden current changes. This means that power provided by the generator must immediately be delivered to the grid so that the DC link voltage can be kept at a desired level. The DC link voltage must be maintained constant in order to keep the converter operational, and this can hence only be ensured by keeping an energy balance between the electrical generator and the power injected into the grid. As a result transients will arise in the generator power/torque.

According to the solution of FIG. 3, problems of this kind are mitigated through the use of a separate DC link voltage control, which is implemented as a second grid forming controller GFC2 operating in parallel to the first grid forming controller GFC1. The main grid forming control is hence combined with an additional grid forming control, where the second grid forming controller GFC2, according to the present example, has the purpose of maintaining the DC link voltage at a desired voltage level.

According to embodiments of the invention, the second grid forming controller GFC2 may, instead, have another, different, purpose, and, e.g., be utilized to control other power components that may be desired to control. For example, drive train damping, and/or side-side-tower-damping, SSTD, and/or power oscillation damping, POD, may be controlled instead. As will be explained below, a plurality of grid forming control algorithms may be utilized in parallel to control various different power or voltage components.

With regard to DC link voltage control, this may utilize a difference between the currently prevailing DC link voltage Udc, where this voltage may be established as described above, and a DC link voltage reference Udc_ref. The difference may be taken between the squared voltage signals, and by subjecting the obtained error signal to, e.g. a proportional controller (P-controller) a power reference PDCPref is obtained, and which hence is proportional with the DC link voltage difference.

Transient changes in the DC link voltage, which according to the above may cause undesired stress and wear of the drive train components, may then be handled by the second grid forming control GFC2 on the basis of the power value PDCPref, which is hence proportional to the DC link voltage difference. This power value is input to the second grid forming controller GFC2 350, which calculates a voltage component VGFC2, αβ in a similar manner to the calculation of that is combined with the voltage component VGFC1, αβ being calculated by the grid forming control to form an overall output voltage Vαβ to be output by the line side converter. The voltage component VGFC2, αβ controls the DC link voltage towards the power reference, and hence counteracts voltage changes that the DC link would otherwise undergo.

Hence, when, e.g., a transient grid event occurs, according to the present example, a difference in the DC link voltage in relation to the DC link voltage reference will arise in situations where the electrical generator would normally be forced to operate outside its operating limits, but where these limits may now be respected to a greater extent since the transients need not be immediately propagated to the electrical generator.

Differences that arise in the DC link voltage as a result of changes in the power PL being injected into the grid and that are not immediate accounted for by corresponding changes in the power produced by the electrical generator are handled by the second grid forming controller GFC2, which acts to return the DC link voltage level Udc towards the DC link voltage reference. In principle, the second grid forming controller GFC2 may feed back power to the grid instead of requesting the electrical generator to fully account for rapid changes in line side power.

The invention may hence provide for a slight alteration of the general requirement that the line side converter in a grid forming mode is to always maintain the grid voltage reference, since the component added by the second grid forming algorithm will change the overall voltage output by the line side converter, but where this instead will reduce the stress that the electrical generator, and other drivetrain components, may undergo when transient events occur on the grid. Simultaneously, it may be avoided that the converter trips altogether and becomes unusable in the process of maintaining grid stability, and also in regard of providing power to the grid until operation can be reset. Hence it is provided a means that in addition to reducing harmful transients may increase the use of the converter grid stabilizing operations.

In general, the power added by the second grid forming algorithm, and hence the influence on the overall output voltage, may be small in comparison to the overall power being output on the grid, and hence the impact on the maintaining of the grid stability may also be little. Furthermore, while there in general are requirements regarding the first grid forming controller in terms of, e.g., the rate of change of the controller, e.g. limited by an inertia time constant and/or damping factor, the second grid forming controller is not subject to such limitations, and the control of the DC link voltage according to the present example may be configured to be much faster through appropriate setting of the parameters of the second grid forming algorithm, e.g. in terms of inertia time constant and damping, which otherwise may be similar to the algorithm of the first grid forming controller.

Although not explicitly illustrated in FIG. 3, the grid forming controllers also comprise a reactive power control for controlling reactive power. As is known per se, the reactive power control loop in general provides the amplitude control, while the active power control loop provides the voltage angle that controls the active power being injected into the grid. Both the active and the reactive power are required to form the overall output power, and it is therefore necessary to produce reactive power, e.g., in order to control the virtual electrical machine angle.

Furthermore, as was stated, the second grid forming controller may alternatively be configured to control one or more other entities, such as a damping power as was mentioned. Also, although the second grid forming controller is provided with a power according to the present example, the power reference may be configured to be extracted in the grid forming controller instead.

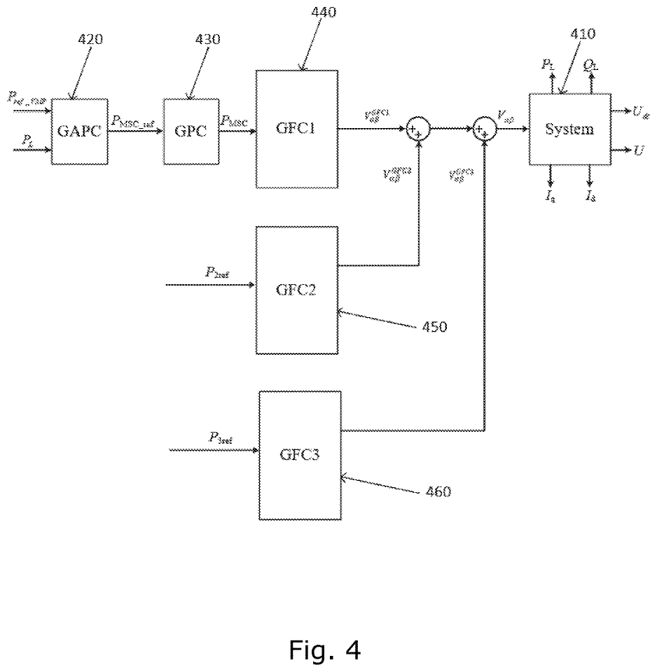

FIG. 4 illustrates a further exemplary embodiment, which is similar in operation to the embodiment of FIG. 3, with the difference that both a second grid forming controller 450 and an additional, third, grid forming controller 460 is utilized to control the output voltage of the line side controller. The additional grid forming controller 460 may be used to control any desired power or voltage component, such as, e.g. drive train damping, side-side-tower-damping, SSTD, and/or power oscillation damping, POD, which hence be controlled in a similar manner as was exemplified for the DC link voltage. In principle, any number of grid forming controllers may be utilized in parallel to control various voltage and/or power components, where, e.g., a voltage component may be controlled as discussed for the DC link control and be converted to a power component. Both of the second and third grid forming controllers of FIG. 4 may also be configured to control e.g. a mechanical damping power, and there is hence no requirement that a DC link control is performed.

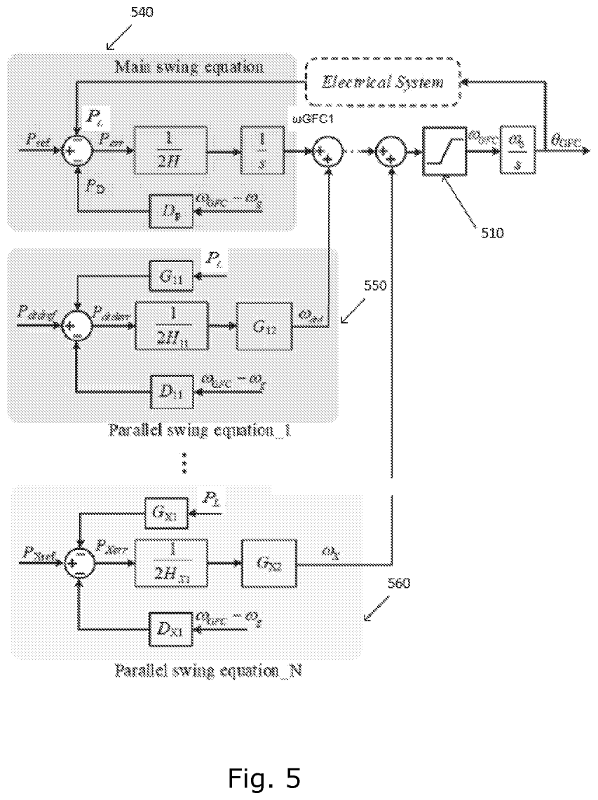

FIG. 5 illustrates a slightly more detailed example according to embodiments of the invention, where the grid forming controllers are controlled according to an algorithm in the form of a swing equation. FIG. 5 illustrates a first grid forming control algorithm in the form of a main swing equation 540 for determining a first voltage component that is used in the determining of a synchronous machine angle θGFC of a virtual synchronous generator.

The synchronous machine angle θGFC is determined based on a virtual synchronous machine control concept which aims at generating a power response which corresponds to the power response from a real synchronous generator, including the inertia of the synchronous generator.

According to the first grid forming control swing equation 540 a power error Perr is determined as a difference between Pref, which, e.g., may be PLref as defined above and the power PL being injected into the grid and a damping power PD being determined according to the virtual synchronous model.

In response to a change in the grid power PL, e.g. due to an decrease in the grid voltage Ugrid and a corresponding increase in the grid current Igrid, the power error Perr becomes non-zero, which causes the angle θVSM to increase or decrease to reduce the power error Perr. Thus, in response to fluctuations, e.g., in the grid power Pgrid, the synthetic inertial response value becomes non-zero, which causes the virtual machine to either accelerate or decelerate to reach a new equilibrium condition. The new equilibrium is reached when PL is again following Pref.

The virtual synchronous model includes a closed loop where the virtual synchronous machine rotational speed ωGFC1 from the main grid forming control swing equation 540 is determined based on a combination of a feedback of the damping power PD, and the power reference Pref for the desired active power output of the wind turbine, and the active grid power PL supplied by the wind turbine to the grid.

The inertial integration model of the main grid forming algorithm 540 is according to the illustrated example implemented as 1/(2Hs) where H is the inertia time constant and 1/s is the integration in s-domain where Perr is used as input for the inertial integration model.

The damping power PD is determined as the difference between the rotational speed of the grid ωg and the synchronous machine rotational speed ωGFC multiplied with the damping factor Dp.

The overall synchronous machine angle θGFC is determined based on an integration of the synchronous machine rotational speed ωGFC according to ω0/s, where ω0 is the rated synchronous generator speed. The synchronous machine angle θGFC however, is determined based also on the synchronous machine rotational speed ωDTD, ωx contributions from the parallel swing equations 550, 560 which are also illustrated in the figure.

The swing equations 550, 560 may be similar to the swing equation 500, however with different parameters, and different control inputs. According to the illustrated example, the swing equation 550 is configured to control drive train damping power, Pdtd, based on a power reference Pdtdref, where G11 and G12 may form weights factors and/or filters adapted for the desired control. Furthermore, the inertia time constant H11 as well as the box G11 may be designed for fast control, to allow for a considerably more responsive, and faster, control in relation to the control of the main swing equation. The damping factor D11 may also be suitably adapted.

The parallel swing equation 550 may hence be configured to extract, e.g., drive train damping power to be injected into the grid, where this may be carried out at a faster rate than if the drive train damping power would be injected via the main swing equation. The box G12 of swing equation 550 may represent, e.g. a filter, but may also, or in addition, also comprise e.g. a weight factor to limit the amount of power to be injected into the grid that is handled by the swing equation. The discussion of swing equation 550 also applies correspondingly to swing equation 560, which according to the illustrated controls a non-specified power Px.

As was mentioned, the parallel swing equations 550, 560 may also be designed to control other frequency bands than the frequency band of the main swing equation 540. For example, the parallel swing equations 550, 560 may be configured to control both low and high frequency components. Each grid forming algorithm may be designed to be aimed at controlling a particular signal, and each algorithm may be tuned to a specific frequency, and to handle only things that occur for that particular frequency/frequency band, while other grid forming controllers may be tuned to a high-pass filtered or low-pass filtered signal in dependence on what component that is desired to dampen.

The various virtual synchronous machine rotational speed outputs of the various swing equations of FIG. 5 are then added together to form a combined synchronous machine angle θGFC, which possibly subjected to a rate limiter 510 prior to the synchronous machine angle θGFC being determined based on an integration of the synchronous machine rotational speed ωGFC according to ω0/s, where ω0 is the rated synchronous generator speed, and where the resulting synchronous machine angle θGFC is used to control power being injected into the grid. Also, as was mentioned above, reactive power is also controlled in a similar manner (not disclosed).

1. A method for controlling a grid connected power converter configured to supply power to a grid from a power source, the method comprising:
determining a grid voltage reference (Pref_VMP) for controlling the power converter;
controlling a first power component being supplied to the grid by the power converter by controlling the power converter using a first grid forming controller configured to control the output voltage towards the grid voltage reference (Pref_VMP), the first grid forming controller operating according to a first grid forming algorithm being configured to output a first voltage component for supplying the first power component to the grid;
controlling a second power or voltage component being supplied to the grid by the power converter by controlling the power converter using a second grid forming controller, operating in parallel to the first grid forming controller, the second grid forming controller operating according to a second grid forming algorithm being configured to output a second voltage component for supplying the second power or voltage component to the grid;
combining the second output voltage component of the second grid forming algorithm with the first output voltage component of the first grid forming algorithm; and
operating the power converter according to the combined output voltage from the first grid forming controller and the second grid forming controller.

2. A method according to claim 1, wherein a bandwidth of a frequency band of the second output voltage component is different from a bandwidth of a frequency band of the first output voltage component.

3. A method according to claim 1, further comprising:
controlling at least one additional power component being supplied to the grid by the power converter by controlling the power converter using at least one additional grid forming controller, operating in parallel with the first and second grid forming converter, each of the at least one additional grid forming converters operating according to a grid forming algorithm, respectively, for supplying a power or voltage component to the grid;
the output voltage component(s) of the at least one additional grid forming controller being combined with the output voltage components of the first and second grid forming controllers; and
operating the power converter according to the combined output voltage from the first, second and the at least one additional grid forming controller.

4. A method according to claim 3, wherein at least one, or each, of the at least one additional grid forming controllers is configured to output a voltage component with a frequency band being at least partly non-overlapping with a frequency band of the first output voltage component, and/or wherein each grid forming controller is configured to output a voltage component with a frequency band being different from the frequency band of the first output voltage component and/or being different from any output voltage component of any other grid forming controller.

5. A method according to claim 1, wherein each grid forming controller is configured to output a voltage component having a frequency and a phase angle.

6. A method according to claim 1, further comprising:
controlling the frequency range of the output voltage component being output by the second and/or at least one additional grid forming controller utilizing a band-pass filter, a low-pass filter, and/or other type of filter.

7. A method according to claim 1, wherein the grid forming controllers each comprises an algorithm, such as a swing equation, each algorithm having a parametrization being different from the parametrization of the one or more other algorithms.

8. A method according to claim 7, further comprising:
each swing equation being configured to control a power component, respectively, through output of a voltage component utilizing one or more from an integrator, an inertia time constant and a damping of frequency deviation, parameters of the integrator, inertia time constant and damping of frequency deviation being different for the different swing equations.

9. A method according to claim 1, wherein:
each grid forming control controller is configured to control a voltage or power component in dependence of a power or voltage refence, the grid forming algorithm of the grid forming controller being configured to output an output voltage component in response to the difference to be combined with output voltage component of the at least one other grid forming controller.

10. A method according to claim 1, further comprising:
compensating power output by an electric generator forming the power source by a drive train damping power to dampen drive train fundamental frequency oscillations, wherein the drive train damping power is compensated by supplying the drive train damping power to the grid, the drive train damping power being supplied to the grid utilizing the second or one of the at least one additional grid forming controllers.

11. A method according to claim 1, wherein a DC link electrically connects an output of a machine side converter to an input of a line side converter, the method further comprising:
controlling the DC link voltage of the DC link towards a DC link voltage reference utilizing the second or one of the at least one additional grid forming controllers, wherein the grid forming controller outputs an output voltage component controlling the DC link voltage towards the DC link voltage reference.

12. A method according to claim 1, wherein:
the frequency band or bands being controlled by the second and/or the at least one additional grid forming controller comprises higher or lower frequency components than the frequency band being controlled by the first grid forming controller.

13. A method according to claim 1, wherein the first grid forming controller is configured to control the majority of the power being injected into the grid by the power converter.

14. A method according to claim 1, further comprising:
compensating SSTD (side-side-tower-damping) and/or POD (power oscillation damping) and/or other kinds of mechanical damping, wherein the SSTD and/or POD and/or the other mechanical damping is compensated by supplying the SSTD and/or POD and/or other mechanical damping compensating power to the grid, the compensating power being supplied to the grid utilizing the second and/or one or more of the at least one additional grid forming controllers.

15. A method according to claim 1, wherein the impact of each grid forming controller on the combined output voltage is controlled by means of a weight factor, the weight factor limiting the amount of power to be injected into the grid by the particular grid forming controller.

16-19. (canceled)

20. A computer-readable medium comprising instructions which, when the instructions are executed by a computer, cause the computer to perform an operation for controlling a grid connected power converter configured to supply power to a grid from a power source, the operation comprising:
determining a grid voltage reference for controlling the power converter;
controlling a first power component being supplied to the grid by the power converter by controlling the power converter using a first grid forming controller configured to control the output voltage towards the grid voltage reference, the first grid forming controller operating according to a first grid forming algorithm being configured to output a first voltage component for supplying the first power component to the grid;
controlling a second power or voltage component being supplied to the grid by the power converter by controlling the power converter using a second grid forming controller, operating in parallel to the first grid forming controller, the second grid forming controller operating according to a second grid forming algorithm being configured to output a second voltage component for supplying the second power or voltage component to the grid;
combining the second output voltage component of the second grid forming algorithm with the first output voltage component of the first grid forming algorithm; and
operating the power converter according to the combined output voltage from the first grid forming controller and the second grid forming controller.

21. A wind power installation control system, comprising:
a rotor;
an electrical generator driven by the rotor; and
a power converter configured to supply power to a grid; wherein the wind power installation control system is configured to perform an operation, comprising:
determining a grid voltage reference for controlling the power converter;
controlling a first power component being supplied to the grid by the power converter by controlling the power converter using a first grid forming controller configured to control the output voltage towards the grid voltage reference, the first grid forming controller operating according to a first grid forming algorithm being configured to output a first voltage component for supplying the first power component to the grid;
controlling a second power or voltage component being supplied to the grid by the power converter by controlling the power converter using a second grid forming controller, operating in parallel to the first grid forming controller, the second grid forming controller operating according to a second grid forming algorithm being configured to output a second voltage component for supplying the second power or voltage component to the grid;
combining the second output voltage component of the second grid forming algorithm with the first output voltage component of the first grid forming algorithm; and
operating the power converter according to the combined output voltage from the first grid forming controller and the second grid forming controller.
